(19) United States
(12) Patent Application Publication
(10) Pub. No.: US 2017/0048600 A1
(43) Pub. Date: Feb. 16, 2017

(54) SOUND GENERATING DEVICE AND METHOD FOR MAKING SAME

(71) Applicants: Xiaofeng Pu, Shenzhen (CN); Qun Xiang, Shenzhen (CN); Xudong Yan, Shenzhen (CN); Bin Zhao, Shenzhen (CN); Sheng Ye, Shenzhen (CN)

(72) Inventors: Xiaofeng Pu, Shenzhen (CN); Qun Xiang, Shenzhen (CN); Xudong Yan, Shenzhen (CN); Bin Zhao, Shenzhen (CN); Sheng Ye, Shenzhen (CN)

(73) Assignee: AAC Technologies Pte. Ltd.,, Singapore (SG)

(21) Appl. No.: 15/082,304

(22) Filed: Mar. 28, 2016

(30) Foreign Application Priority Data
Aug. 11, 2015 (CN) 201510490567.6

(51) Int. Cl. H04R 1/02; H04R 1/32

(52) U.S. Cl. CPC H04R 1/026; H04R 1/023; H04R 1/323; H04R 2499/11

(57) ABSTRACT

A sound generating device is provided in the present disclosure. The sound generating device includes a shell providing a receiving cavity, a sound generating body received in the receiving cavity and assembled to the shell, sound absorbing material filled in the receiving cavity, and an isolating member attached on the sound generating body. The sound generating body includes at least one air hole, and the isolating member covers the at least one air hole, the isolating member is configured for isolating the sound absorbing material from entering the sound generating body. The present disclosure further provides a method for making a sound generating device.

### FIELD OF THE DISCLOSURE

The present disclosure relates to electro-acoustic converting technologies, and more particularly, to a sound generating device applicable to a mobile terminal and a method for making the sound generating device.

### BACKGROUND

Sound generating devices are widely applied in mobile terminals, such as mobile phones, tablet computers, laptop computers, portable game players, portable multimedia devices, or the like, for converting electrical signals into audible sounds. A typical sound generating device includes a shell providing a hermetic cavity and a sound generator receiving in the hermetic cavity.

Due to a miniaturization trend of the mobile terminal, the sound generating device is required to have a small size, and thus an inner space of the hermetic cavity is limited. However, the limited space of the hermetic cavity may cause a resonance frequency of the sound generating device to be high; therefore, a low frequency performance of the sound generating device is impacted.

Therefore, it is desired to provide a new sound generating device which can overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a cross-section view of a sound generating device according to an embodiment of the present disclosure.

### DETAILED DESCRIPTION

The present disclosure will be described in detail below with reference to the attached drawings and the embodiment thereof.

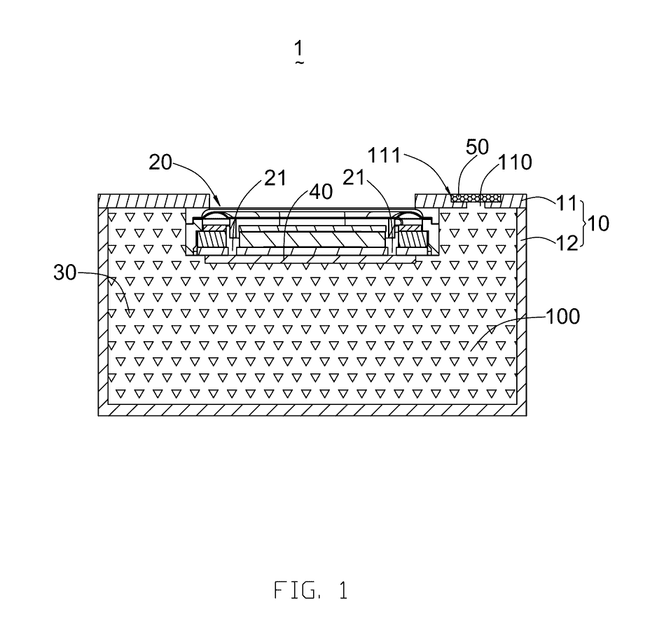

Referring to FIG. 1, a sound generating device 1 according to an embodiment of the present disclosure is shown. The sound generating device 1 is applicable to a mobile terminal such as a mobile phone, a tablet computer, a laptop computer, a portable game player, a portable multimedia device, or the like. The sound generating device 1 includes a shell 10 for providing a receiving cavity 100, and a sound generating body 20 assembled to the shell 10 and received in the receiving cavity 10 of the shell 10.

The shell 10 includes a main housing 12 and a cover 11, the cover 11 covers the main housing 12 for forming the receiving cavity 100. In the present embodiment, the sound generating device 1 further includes sound absorbing material 30 filled in the receiving cavity 100, and an isolating member 40 located between the sound generating body 20 and the sound absorbing material 30. The sound absorbing material 30 may be in form of sound absorbing powder, and the isolating member 40 may be an isolating mesh for isolating the sound absorbing material 30 from entering the sound generating body 20, for example, the isolating member 40 may be a dust-proof cloth.

The sound generating body 20 include at least one air hole 21 for providing an air excreting path for the sound generating body 20, the at least one air hole 21 is communicated with both the receiving cavity 100 of the shell 10 and an inner space of the sound generating body 20. In the present embodiment, the at least one air hole 21 is formed in a bottom of the sound generating body 20; alternatively, the at least one air hole 21 may also arranged in a sidewall of the sound generating body 20. The isolating member 40 may be arranged on a bottom surface of the sound generating body 20 to cover the at least one air hole 21.

The shell 10 may further include a filling opening 110 for filing the sound absorbing material 30 into the receiving cavity 100. In the present embodiment, the filling opening 110 is formed in the cover 11 as illustrated in FIG. 1; alternatively, the filling opening 110 may be formed in the main housing 12 in other embodiments.

Furthermore, the sound generating device 1 may further include a sealing member 50 covering the filling opening 110. The sealing member 50 is provided for sealing the sound absorbing material 30 within the receiving cavity 100, and may be selected form a PET (polyethylene terephthalate) film or a dust-proof cloth.

In the present embodiment as illustrated in FIG. 1, the filling opening 110 is formed in the cover 11, and the cover 11 also includes a groove 111 formed around the filling opening 110, the sealing member 50 is arranged in the groove 111 and attached to the shell 10. The groove 111 enables a top of the sealing member 50 to be level with the cover 11, and thereby ensuring flatness of the shell 10. When the filling opening 110 is formed in the main housing 12, the groove 111 may correspondingly be arranged in a relevant region of the main housing 10 so that the sealing member 50 received therein can cover the filling opening 110.

In the sound generating device 1 as provided in the present disclosure, the sound absorbing material 30 can provide air pressure compensation which is equivalent to expanding an inner space of the receiving cavity, thus a resonance frequency in the receiving cavity 100 is reduced and a low frequency response of the sound generating device 1 is enhanced.

Accordingly, the low frequency performance of the sound generating device 1 is improved. Furthermore, the sound absorbing material 30 is directly filled in the receiving cavity 100, the inner space of the receiving cavity 100 can be fully utilized in despite of a cavity shape of the receiving cavity 100, therefore, the receiving cavity 100 can be fully filled with the sound absorbing material 30, and the low frequency performance of the sound generating device 1 can further be ensured.

Based on the sound generating device 1 as described above, the present disclosure further provides a method for making a sound generating device, which can be used to make the sound generating device 1 as illustrated FIG. 1. The method for making the sound generating device mainly includes the following steps:

Step A, a cover 11, a main housing 12, a sound generating body 20 and an isolating member 40 is provided. One of the cover 11 and the main housing 12 include a filling opening 110, and the sound generating body 20 includes an air hole 21 communicated with an inner space of the sound generating body 20.

Step B, the cover 11, the main housing 12, the sound generating body 20 and the isolating member 40 is assembled;

Specifically, the cover 11 is assembled to the main housing 12 to form a shell 10 with a receiving cavity 100; the sound generating body 20 is received in the receiving cavity 100 and is assembled to the shell 10; the insolating member 40 is attached on the sound generating body 20 to cover the air hole 21.

Step C, sound absorbing material 30 is provided and filled into the receiving cavity 100 of the shell 10 via the filling opening 110, until the receiving cavity 100 is fully filled with the sound absorbing material 30.

Step D, a sealing member 50 is provided and attached to the shell 10 to cover the filling opening 110. In particular, the shell 10 may include a groove 111 formed in the cover 11 or the main housing 12 and surrounding the opening 110, and in step S4, the sealing member 50 is arranged in the groove 111 when being attached to the shell 10.

It should be noted that in step B of the method for making the sound generating device, the isolating member 40 can be firstly attached onto the sound generating body 20, and then the sound generating body 20 is assembled to the shell 10; alternatively, the sound generating body 20 is firstly assembled to the shell 10, and then the isolating member 40 is attached onto the sound generating body 20. Furthermore, the sound generating body 20 can be firstly assembled to the cover 11 and then the cover 11 is assembled to the main housing 12; the sound generating body 20 can be firstly assembled to the main housing 12, and then the cover 11 is assembled to the main housing 12.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sound generating device, comprising:
a shell for providing a receiving cavity;
a sound generating body received in the receiving cavity and assembled to the shell, the sound generating body comprises at least one air hole;
sound absorbing material filled in the receiving cavity; and
an isolating member attached on the sound generating body and covering the at least one air hole, the isolating member being configured for isolating the sound absorbing material from entering the sound generating body.

2. The sound generating device of claim 1, wherein the shell comprises a filling opening for filling the sound absorbing material into the receiving cavity.

3. The sound generating device of claim 2, wherein the shell further comprises a cover and a main housing, the cover covers the main housing for forming the receiving cavity.

4. The sound generating device of claim 4, wherein the filling opening is formed in the cover of the shell.

5. The sound generating device of claim 4, wherein the filling opening is formed in the main housing of the shell.

6. The sound generating device of claim 2, wherein the shell further comprises a groove formed around the filling opening, and the sound generating device further comprises a sealing member arranged in the groove and covering the filling opening for sealing the sound absorbing material within the receiving cavity.

7. The sound generating device of claim 6, wherein the sealing member is a polyethylene terephthalate film or a dust-proof cloth.

8. The sound generating device of claim 1, wherein the air hole is formed in a bottom or a sidewall of the main housing.

9. The sound generating device of claim 1, wherein the sound absorbing material is in form of sound absorbing powder.

10. The sound generating device of claim 1, wherein isolating member is a dust-proof cloth.

11. A method for making a sound generating device, comprising steps of:
providing a cover, a main housing, a sound generating body with at least one air hole, and an isolating member,;
assembling the cover to the main housing for forming a shell with a receiving cavity, and assembling the sound generating body to the shell in the receiving cavity;
attaching the isolating member on the sound generating body to cover the at least one air hole; and
providing sound absorbing material and filing the sound absorbing material into the receiving cavity.

12. The method of claim 11, further comprising: forming a filling opening in the shell for filing the sound absorbing material into the receiving cavity.

13. The method of claim 12, wherein the filling opening is formed in the cover or the main housing.

14. The method of claim 12, further comprising: providing a sealing member, and attaching the sealing member to the shell for covering the filling opening.

15. The method of claim 14, further comprising: forming a groove around the filling opening in the shell.

16. The method of claim 15, wherein the sealing member is arranged in the groove.

17. The method of claim 11, wherein the isolating member attached onto the sound generating body before the sound generating body being assembled to the shell.

18. The method of claim 11, wherein the sound generating body is assembled to the shell before the isolating member being attached onto the sound generating body.

19. The method of claim 11, wherein the sound generating body is assembled to the cover before the cover being assembled to the main housing.

20. The method of claim 11, wherein the sound generating body is assembled to the main housing before the cover being assembled to the main housing.
